(19) United States
(12) Patent Application Publication
(10) Pub. No.: US 2026/0211660 A1
(43) Pub. Date: Jul. 23, 2026

(54) INFORMATION TECHNOLOGY SYSTEM, VEHICLE AND METHOD FOR APPLYING AN UPDATE TO A TARGET SYSTEM

(71) Applicant: MERCEDES-BENZ GROUP AG, Stuttgart (DE)

(72) Inventor: Thorsten WILMER, Sindelfingen (DE)

(21) Appl. No.: 19/157,777

(22) PCT Filed: Feb. 2, 2024
(86) PCT No.: PCT/EP2024/052671

§ 371 Date: Aug. 19, 2025

(30) Foreign Application Priority Data
Feb. 20, 2023 (DE) 10 2023 000 563.0

(51) Int. Cl. G06F 8/65; H04L 1/1829

(52) U.S. Cl. CPC G06F 8/65; H04L 1/1835

(57) ABSTRACT

An information technology system includes a source and target system that can communicate information via a bidirectional data line. The source system, the target system, or both the source and target system each has/have a data transfer acceleration module for accelerating the information transmission from the source system to the target system.

### BACKGROUND AND SUMMARY OF THE INVENTION

Exemplary embodiments of the invention relate to an information technology system, a vehicle, and a method for applying an update to a target system.

With increasing digitalization, the relevance of computer systems for use in vehicles also increases. Nowadays, modern vehicles have a plurality of different control devices, for example for controlling the combustion process of a combustion engine, for adjusting the chassis with an active suspension and for providing driver assistance systems, such as for example an adaptive cruise control, a high beam assistant, and similar. With increasing degrees of automation, corresponding control devices have to process more data in a shorter amount of time. The computing needs increase accordingly. Thus, to provide a fully automated or even autonomous driving function, it is necessary to integrate the most advanced graphic processors into vehicles that can calculate a plurality of matrix operations in a short time.

It can be necessary to update the programs that can be executed by the corresponding control devices several times over the service life of a vehicle. These updates can relate to both the firmware of a control device, as well as an application program executed on a corresponding control device. Along with the exchange of individual code sections and the application of completely new code sections, parameter sets can also be exchanged in the process. For example, the parameter of a rain sensor can be changed, so that an automatically activated windscreen wiper is only activated when there is a relatively large amount of precipitation. Similarly, characteristic maps can be adapted, for example the speed characteristic map of an oil delivery pump depending on an oil temperature. Additionally, new functions can be implemented and security vulnerabilities closed due to the application of corresponding updates into said computer systems in the vehicle.

It is desirable to install corresponding updates as fast as possible on the computer systems. While installing an update, the computer system may not available, so that the functionality to be provided by the computer system cannot be used. A vehicle user has to wait accordingly, which reduces convenience. Additionally, particularly security-relevant updates are to be installed quickly, in order to prevent an attacker, for example a hacker, corrupting said computer system. The larger an update, i.e., the more data that is to be applied, the more urgent it is to ensure acceleration.

The communication with the computer systems installed in a vehicle is possible in a variety of ways. Typically, vehicles have an on-board diagnostic interface, via which the communication of a vehicle-external computer system with the vehicle-internal computer system is handled. In this case, special communication protocols are used, such as, for example, the communication protocol Unified Diagnostic Services described by ISO 14229. A vehicle-external computer system, for example a desktop computer, laptop, or tablet computer, can be coupled using a cable, for example via USB or Ethernet, or also wirelessly, for example via Bluetooth or WiFi, to a corresponding vehicle-internal computer system. To increase the user convenience, updates can also be applied to a vehicle via mobile radio. Thus, a vehicle user does not have to find a workshop any more or manually download an update onto a desktop computer via the internet, upload this to a USB stick, and then plug the USB stick into a corresponding socket in the vehicle so that the update can be installed. Instead, the vehicle uses a telematics unit to access a corresponding server of a vehicle manufacturer via mobile radio and downloads the update.

The interaction between vehicle-internal and vehicle-external computer systems represents an innovative area. For example, DE 10 2012 110 559 A1 describes a method for securely downloading a firmware using a diagnostic link connector and the OnStar system. To increase the cybersecurity, the firmware to be implemented on a vehicle-internal computer system is signed by two different actors, and thus twice.

Furthermore, DE 10 2019 216 841 A1 describes a vehicle diagnostic communication device and a system containing the same. The vehicle diagnostic communication device is therefore set up to estimate a time needed for carrying out diagnostics.

A network interface system is disclosed in U.S. Pat. No. 7,787,481 B1, which connects a central computer to a network for the exchange of data. The network interface system comprises a storage system and a media access control system having at least one local cache, which is designed to read a second data structure from the storage system while a first data structure is being transmitted to the network. This is meant in particular to improve access to the storage system for several end devices connected to the network.

US 2014/0019571 A1 describes a method for processing data packets from a receive queue for data packets in a device for memory access. Depending on the use of the receive queue when programs access data packets, the usage of a further queue is proposed, which is provided for heuristically predictive caching of data packets.

Exemplary embodiments of the present invention are directed to an improved information technology system, with the aid of which the application of updates to a computer system can be accelerated.

A generic information technology system, comprising:
a source system, in turn having a source information storage and a file reader module and a system interface module; and
a target system, in turn having a target information storage and a system interface module, a payload buffer module and a storage access module; wherein
the source system and the target system are communicatively coupled to each other via a bidirectional data line;
the source system is set up to read out the source information storage after receiving a response message from the target system by means of the file reader module, to pack information read out from the source information storage to form a data transfer block and to send this to the target system via the data line; wherein
the source system requires a first latency time for reading out the source information storage and packing the data transfer block;
the target system is set up to receive the data transfer block, to extract the information contained therein and to write same into the payload buffer module, then to create a response message and to transmit the information from the payload buffer module to the target information storage by means of the storage access module; wherein
the target system requires a second latency time for extracting and writing the information and for creating the response message;
   is further developed according to the invention in that
the source system and/or the target system each further comprise a data transfer acceleration module, in turn having a data transfer block buffer; wherein
the data transfer acceleration module is arranged in the source system between the data line and system interface module and is set up to receive a first data transfer block and to send it via the data line, to output a response message to the system interface module itself after receiving a data transfer block, in order to cause the packing of at least one further data transfer block, to cache the further data transfer block in the data transfer block buffer and to send a further data transfer block cached in the data transfer block buffer to the target system after receiving a response message from the latter; and wherein
the data transfer acceleration module is arranged in the target system between the data line and the system interface module and is set up to receive a first data transfer block and to pass it to the system interface module, to output a response message itself after receiving a data transfer block and to send this via the data line, in order to cause the sending of at least one further data transfer block from the source system to the target system, to cache at least one further data transfer block in the data transfer block buffer and to pass a further data transfer block to the system interface module after receiving a response message from the system interface module, or to send a negative response message via the data line after receiving the negative response message from the system interface module and to delete all further data transfer blocks from the data transfer block buffer.

With the aid of the information technology system according to the invention, the time period for transmitting information from the source system to the target system can be reduced. The context is that while the target system is working, i.e., during the second latency time, the source system is inactive or is in idle mode.

However, the source system requires a first latency time in order to read out the source information storage by means of the file reader module and to pack a corresponding data transfer block therefrom. The information technology system according to the invention is designed in such a way that the source system, while the target system is working, i.e., during the second latency time, is similarly active, so that the time the target system has to wait after the response message has been sent until a corresponding further data transfer block is received from the source system is reduced. The first latency time can be in a magnitude of 100 ms and the second latency time can be in a magnitude of 600 ms. For each data transfer block to be transmitted, a corresponding queue can be reduced, for example in the magnitude of 200 to 300 ms. When this is added to the entirety of the data transfer blocks to be transmitted from the source system to the target system, this means that a significant time reduction for applying corresponding data or information to the target system is possible.

For each execution of the source system and target system, the first latency time can also be greater than the second latency time.

The data transfer acceleration module can be implemented only in the source system, only in the target system or also in each case in both systems. Due to the arrangement between the data line and the respective system interface module, the data transfer acceleration module can be incorporated very simply into the respective system. The architecture of the source system or target system does not have to be adapted, as the data transfer acceleration module is mounted upstream in each case of the source system or target system in a corresponding data flow direction.

In general, the information technology system is a network of computer systems. Accordingly, the source system and the target system form a computer system. A respective computer system comprises hardware and/or software components. This can be in each case any computing device, such as a desktop computer, laptop, tablet computer, smartphone, an embedded system, designed for example as a system-on-a-chip, a server, an edge computing device and similar.

The information to be transmitted from the source system to the target system may be all conceivable information, i.e., files and corresponding file formats. It may be a program code for designing an executable program, such as a firmware or an application program or also information to be processed by a corresponding executable program, such as parameters, constants and similar.

The source information storage and the target information storage is in each case a computer-readable physical storage medium. Here, all conceivable designs qualify.

The file reader module, a respective system interface module, the payload buffer module, and the storage access module are formed by hardware and/or software. Particularly preferably, they are purely software modules. The source system is able to at least read access the source information storage by means of the file reader module. The file reader module can also be referred to as a file reader. The system interface module serves as a connection interface and can also be referred to as a dialogue sequencer on the source system side. The system interface module can also be referred to as a diagnostic module in the target system. This is in particular the case when the target system is a vehicle diagnostic communication module. The payload buffer module serves to cache the information to be written into the target information storage. The target information storage can have a cycle deviating from the rest of the target system. In order to take account of this, the storage access module can work with the cycle of the target information storage and thus asynchronously read out information from the payload buffer module. The storage access module can also be referred to as a flash access.

The source system and the target system can each contain further hardware and/or software modules, which will not be discussed in more detail here.

Also, the respective data transfer acceleration modules can be formed by hardware alone, by software alone or by a combination of hardware and software.

The bidirectional data line may be a wired or wireless data line. A wired data line can be formed, for example, by an Ethernet cable or a USB cable. Corresponding communication protocols are used. The data line may also be a direct access to a bus system, such as for example, a CAN bus. A wireless data line is formed, for example, by an NFC connection, Bluetooth connection, WiFi connection or similar. Similarly, a mobile radio connection qualifies as a wireless data line.

The response message output by the target system serves to inform the source system that the target system is now ready to receive a further data transfer block.

A data transfer block can also be described as a message. This message or data transfer block comprises one or more headers, which contain information as to how the respective data transfer block is to be further processed on the target system.

Furthermore, a so-called payload is a component of the corresponding message, i.e., of the data transfer block. The payload is the actual information to be written into the target information storage. When the data transfer block moves through the individual modules on the target system, gradually parts of the header are removed from each module until the payload finally ends up in the payload buffer module and subsequently in the storage access module or in the target information storage.

The size of the data transfer block buffer can be configured arbitrarily. In this case, the size of the data transfer block buffer of the data transfer acceleration module in the source system and of the data transfer acceleration module in the target system can be the same size or also different. For example, the data transfer block buffer is so large that at least ten data transfer blocks can be written into it.

The target system is able to create a negative response message and to send it to the source system, with which the source system is informed that the target system can now not receive any more further data transfer blocks. Accordingly, a data transfer acceleration module implemented in the source system can process such a negative response message. In this case, the data transfer block buffer of the data transfer acceleration module in the source system can also be emptied. The file reader module and the system interface module in the source system are then instructed accordingly by the data transfer acceleration module to not create any more further data transfer blocks until a new response message has been received from the target system.

An advantageous development of the information technology system provides that the data transfer acceleration module in the source system and/or in the target system is also set up to output response messages for so long until the respective data transfer block buffer is full. This means that the required time period for transmitting information from the source system to the target system can be reduced even further. In other words, the respective data transfer acceleration module can work continuously independently from the functioning of the target system, until the respective data transfer block buffer is filled.

According to a further advantageous embodiment of the information technology system, the source system and the target system are set up to use Unified Diagnostic Services as a communication protocol. This enables the use of the information technology system in the automotive field. The target system may then be, for example, the computer architecture in a vehicle, or parts of the computer architecture form the target system. The target system can then be accessed by the source system, colloquially speaking, by vehicle diagnostics. In this case, the source system is a corresponding developer computer or software executed on such a developer computer. In this context, the source system is also referred to as a tester. The target system is also referred to as a target in this context. For example, the source system is designed as a DTS9 development tester.

A further advantageous embodiment of the information technology system according to the invention also provides that the source information storage and/or the target information storage comprises flash memory. Flash memory can respond particularly fast and does not comprise any moving parts that could make access difficult due to vibrations, for example when a corresponding vehicle drives over bumps. Thus, flash memory is particularly well-suited for forming said source information storage and/or target information storage. The flash memory can be fixedly installed in the source system and/or target system, or it may also be a releasable storage module, such as an M.2 SSD, an SD card or similar.

According to a further advantageous embodiment of the information technology system, the target system is designed as an embedded system. In this case, the target system can have one or more computing units. Such a computing unit is, for example, a system-on-a-chip, also referred to as a SoC. The target system can be embedded into a vehicle, for example. The target system or the computing unit(s) forming the target system can be formed by control devices of the vehicle.

Preferably, the source system is designed as a server or server cluster and at least one part of the data line runs through the internet. The target system can, for example, be connected to the internet via mobile radio. This enables the target system to receive information from the server or server cluster. The server can be operated or used by a vehicle manufacturer. Thus, information can be distributed from the vehicle manufacturer to the vehicles of its vehicle fleet. Due to the use of the internet and in particular a mobile connection of the vehicles to the internet, the vehicles do not have to go to a workshop in order to receive the information.

In a vehicle according to the invention, a target system, as described above, is a part of the vehicle or is implemented in the vehicle. The vehicle therefore comprises at least one data transfer acceleration module. The vehicle may be any vehicle, such as a car, lorry, van, bus, or similar. Instead of a road vehicle, it may also be a railway vehicle, water vessel, or aircraft.

Furthermore, a method for applying an update to a target system using an information technology system as described above is described. According to the invention, the method provides that a parameter dataset, an application program, and/or a firmware is adapted in the target system or is newly introduced into the latter by means of the update.

By means of the method, it is possible to reduce the required time period required for applying said update to the target system. This is possible due to the functioning of the data transfer acceleration module contained in the used information technology system.

Further advantageous embodiments of the information technology system according to the invention and of the method for applying the update to the target system result from the exemplary embodiments which are described in more detail below with reference to the figures.

### BRIEF DESCRIPTION OF THE DRAWING FIGURES

Here the figures show:

FIG. 1 a schematic illustration of an information technology system known from the prior art;

FIG. 2 a schematic illustration of an information technology system according to the invention, having a data transfer acceleration module implemented on a source system;

FIG. 3 a schematic illustration of an information technology system according to the invention, having a data transfer acceleration module implemented on a target system;

FIG. 4 a schematic illustration of an information technology system according to the invention, having a data transfer acceleration module implemented on each of the source system and the target system; and

FIG. 5 a schematic illustration of the information technology system shown in FIG. 4, in which the data transfer block buffer of both data transfer acceleration modules is full.

### DETAILED DESCRIPTION

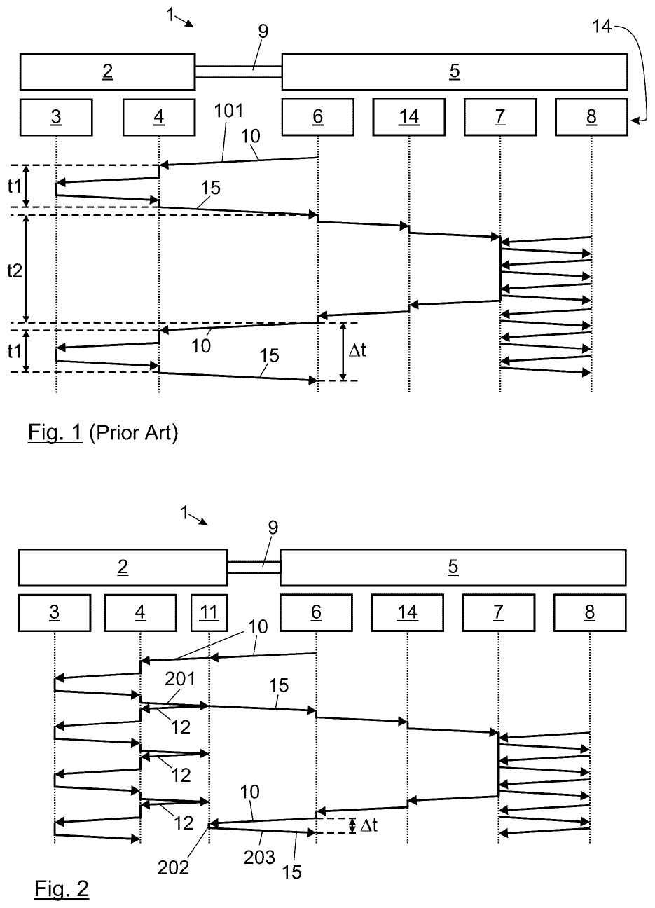

FIG. 1 shows an information technology system 1 known from the prior art. This comprises a source system 2, which is in bidirectional communication with a target system 5 via a data line 9. The source system 2 in turn comprises a file reader module 3 and a system interface module 4. The target system 5 in turn likewise comprises a system interface module 6, a payload buffer module 7, and a storage access module 8. The respective modules are formed by hardware and/or software. The source system 2 and the target system 5 can similarly be formed by hardware components and/or software components. In the exemplary embodiments shown in the figures, the corresponding modules are designed as a software module 14. As illustrated by way of example for the target system 5, the source system 2 and the target system 5 can also have further software modules 14.

The figures each show sections from the process of data transmission between the source system 2 and the target system 5. For instance, information from a source information storage comprised by the source system 2 is to be transmitted to a target information storage of the target system 5 via the data line 9. In this case, the file reader module 3 has at least read access and the storage access module 8 has at least write access to the respective information storages. The file reader module 3 and the storage access module 8 can both also have read and write access.

As soon as the target system 5 is ready to receive information, the target system 5 send a response message 10 to the system interface module 4 of the source system 2 via the system interface module 6. The data transmission does not take place instantaneously, but with a certain latency time, so that in FIG. 1, a corresponding arrow 101 symbolizing the response message 10 not only points to the left but also downwards. The source system 2 requires a first latency time t1 in order to process the corresponding inquiry or request of the target system 5. So, the system interface module 4 communicates with the file reader module 3, which accesses the source information storage. Information read out from the source information storage is then packed to form a data transfer block. The respective processing times of the file reader module 3 and the system interface module 4 are indicated by vertical lines. The file transmission between the file reader module 3 and the system interface module 4 is similarly associated with a certain latency, so that here the arrows are also tilted in the vertical direction.

The source system 2 sends a respective data transfer block to the target system 5 by means of an information message 15.

The target system 5 requires a second latency time t2 for processing the information message 15, i.e., for processing the data transfer block. The second latency time t2 is measured between the receipt of the information message 15 from the system interface module 6 and the output of the response message 10 by the system interface module 6. The information message 15 comprises a header and a payload, wherein the header contains information describing how the information message 15 is to be processed on the target system 5. The payload is the information read out from the source information storage. The data transfer block or the information message 15 successively moves through the individual software modules 14 of the target system 5, with a part of the header being processed or removed at each software module 14. The remaining payload is then written into the payload buffer module 7. The target system 5 outputs a response message 10 after the successful writing. The storage access module 8 accesses the payload buffer module 7 asynchronously, in order to write the corresponding information into the target information storage. Then, the cycle described above starts again.

The target system 5 also has a first time difference At between the output of the response message 10 and the receipt of the next data transfer block by means of the information message 15.

FIG. 2 shows an information technology system 1 according to the invention, in which a data transfer acceleration module 11 is integrated into the source system 2. Here as well, the system interface module 6 transmits a response message 10 to the source system 2, which is passed through from the data transfer acceleration module 11 to the system interface module 4.

Accordingly, the source system 2 packs a data transfer block and passes this on to the data transfer acceleration module 11, indicated by an arrow 201.

The data transfer acceleration module 11 passes the corresponding data transfer block in the form of an information message 15 on to the system interface module 6 of the target system 5. However, with the aid of the data transfer acceleration module 11 it can be now avoided that the source system 2 waits idly until a new response message 10 is received from the target system 5. The data transfer acceleration module 11 itself outputs a response message 12, after which the system interface module 4 and the file reader module 3 become active again and generate a new data transfer block. This further data transfer block is then written into a data transfer block buffer comprised by the data transfer acceleration module 11 for caching. This process takes place continuously, until the data transfer block buffer is full, or until no more information has to be read out from the source information storage.

The process on the target system 5 is analogous to the exemplary embodiment shown in FIG. 1. However, once the target system 5 transmits a new response message 10 to the source system 2, the advantage of the implementation of the data transfer acceleration module 11 in the source system 2 becomes apparent. For instance, after receiving the response message 10 from the target system 5, the source system 2 does not need to first wait for the first latency time t1 until it transmits an information message 15 back to the target system 5. The data transfer acceleration module 11 specifically reads out the further data transfer block from the data transfer block buffer and passes this on directly or, as indicated in FIG. 2 by a comparatively short vertical line 202, after a comparatively short amount of time by means of the information message 15, indicated by an arrow 203, to the system interface module 6 of the target system 5.

A comparison of FIG. 1 and FIG. 2 shows that in this case, the first time difference Δt is shorter than with the information technology system 1 represented in FIG. 1 and known from the prior art. The time savings add up over all data transfer blocks to be exchanged between the source system 2 and the target system 5 via the data line 9, so that the required time period for transmitting the information is significantly reduced. For example, parameter datasets, firmware, or an application program can be updated faster or newly introduced into the target system 5.

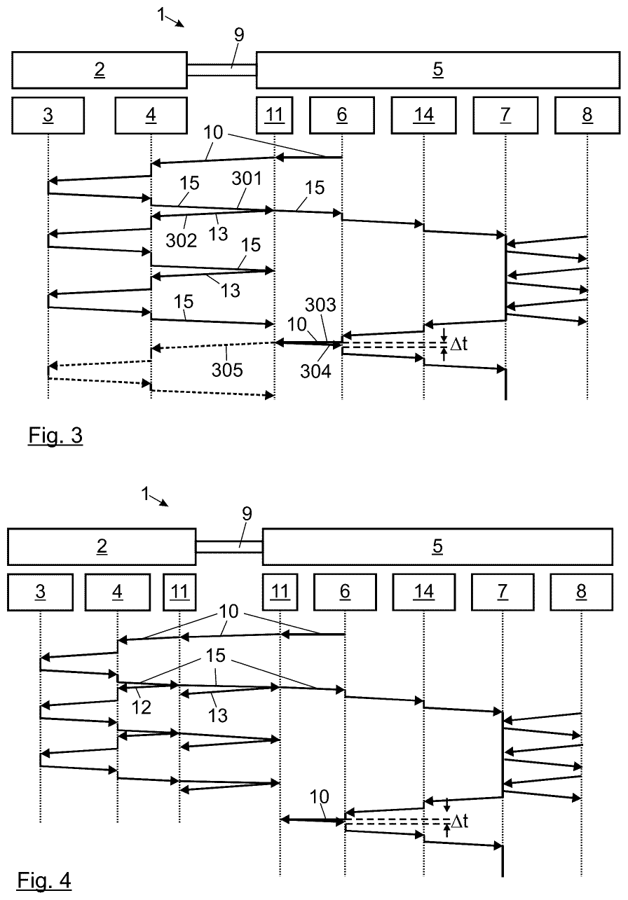

FIG. 3 shows a further possible embodiment of the information technology system 1 according to the invention. Here, a data transfer acceleration module 11 is implemented in the target system 5. The system interface module 6 outputs the response message 10, which is passed on to the source system 2 by the data transfer acceleration module 11. Accordingly, a data transfer block is now generated by the source system 2 and is transmitted in an information message 15 to the target system 5, see arrow 301.

The data transfer acceleration module 11 passes the data transfer block comprised by the information message 15 to the system interface module 6. The process ensuing on the target system 5 is analogous to the embodiment in FIGS. 1 and 2.

However, the data transfer acceleration module 11 now sends its own response message 13, see arrow 302, to the source system 2 to accelerate the data transfer. Then, the source system 2 creates a further data transfer block and transmits this back to the data transfer acceleration module 11 of the target system 5 via the data line 9. Here as well, the data transfer acceleration module 11 comprises a data transfer block buffer in which the data transfer block thus received is cached. This process can run several times consecutively, until the data transfer block is completely filled or no further information has to be transmitted between the source system 2 and the target system 5.

After writing the payload into the payload buffer module 7, the system interface module 6 passes, indicated by an arrow 303, the response message 10 to the data transfer acceleration module 11. The data transfer acceleration module 11 then accesses the data transfer block buffer and is able to directly transmit a further data transfer block, cached in the data transfer block buffer, back to the system interface module 6, indicated by an arrow 304. Thus, not only the waiting period associated with the first latency time t1, but also the waiting period associated with the data transmission via the data line 9 is eliminated. Accordingly, here the first time difference Δt is also reduced.

If the corresponding data transmission method is to be maintained, the data transfer acceleration module 11 passes the response message 10, indicated by an arrow 305, to the system interface module 4 of the source system 2, so that here further data transfer blocks are generated. Depending on time overlap between the transmission of the response messages 10 and 13, here the data transfer acceleration module 11 can also wait, so that instead of a response message 13, the response message 10 is then transmitted (not shown).

In contrast, if the data transfer acceleration module 11 receives a negative response message (not shown) from the system interface module 6, which means that the target system 5 does not accept any further information, the data transfer acceleration module 11 can further convey the negative response message to the system interface module 4 of the source system 2, so that the source system 2 ends the creation of the data transfer blocks or at least pauses it until a new response message 10 has been received from the target system 5. Simultaneously, the data transfer acceleration module 11 deletes the data transfer block buffer.

FIG. 4 shows a further embodiment of the information technology system 1 according to the invention, in which both the source system 2 as well as the target system 5 each have a data transfer acceleration module 11. The advantages described in FIGS. 2 and 3 are thus combined in relation to the time period required for transmitting information from the source system 2 to the target system 5.

In general, it is therefore possible that the data transfer block buffer of the data transfer acceleration module 11 can be filled faster in the target system 5 due to the combined provision of one data transfer acceleration module 11 each in the source system 2 and in the target system 5. However, this depends on whether data transfer blocks are already contained in the source system 2 by the data transfer block buffer of the data transfer acceleration module 11 and on the first latency time t1 and the latency time in the case of the data transmission via the data line 9. In the exemplary embodiment shown in FIG. 4, the data transfer block buffer of the data transfer acceleration module 11 in the source system 2 is initially empty. Additionally, the first latency time t1 is greater than the latency time of the data transmission via the data line 9. Thus, the data transfer acceleration module 11 in the source system 2 can only transmit a further data transfer block to the data transfer acceleration module 11 in the target system 5 as soon as such a data transfer block has been passed on by the system interface module 4. Were the first latency time t1 to be shorter than the latency time in the case of the data transmission by the data line 9, in contrast a data transfer block would already be located in the data transfer block buffer when the data transfer acceleration module 11 of the source system 2 receives the response message 13, which could then be directly transmitted to the target system 5 via the data line 9.

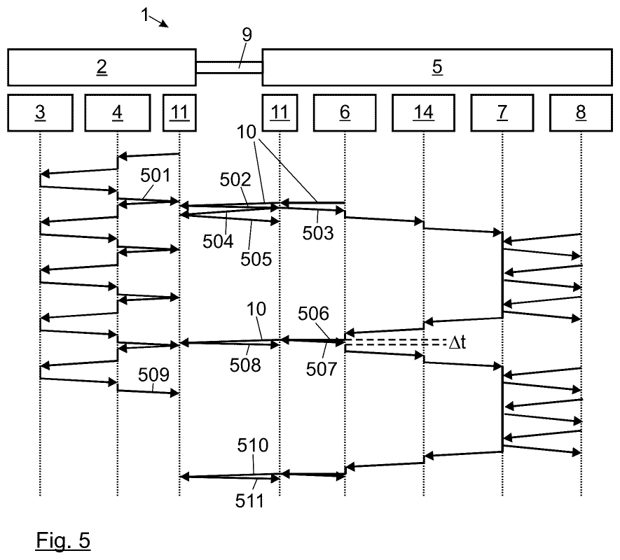

FIG. 5 illustrates an exemplary embodiment in which both data transfer block buffers are already partially filled, and in the further course of the process are completely filled. A further data transfer block is written into the data transfer block buffer of the data transfer acceleration module 11 in the source system 2, illustrated by an arrow 501.

The target system 5 informs the source system 2 by transmitting the response message 10 that it is ready to receive information. As corresponding data transfer blocks are already contained in the data transfer block buffer of the data transfer acceleration module 11 of the source system 2, such a data transfer block can be directly transmitted to the target system 5, indicated by an arrow 502.

This data transfer block is then, indicated by an arrow 503, transmitted from the data transfer acceleration module 11 in the target system 5 to the system interface module 6. Accordingly, the data transfer acceleration module 11 of the target system 5 sends a response message 13 to the source system 2, indicated by an arrow 504.

As data transfer blocks in the data transfer block buffer are contained in the source system 2, as explained above, the data transfer acceleration module 11 of the source system 2 can directly transmit a further data transfer block to the target system 5, indicated by an arrow 505. In the exemplary embodiment shown here, the data transfer block buffer of the data transfer acceleration module 11 in the target system 5 is now full, so that no more further response messages 13 are transmitted to the source system 2. As, however, the data transfer block buffer in the source system 2 is still not full, this is filled further.

Indicated by an arrow 506, the system interface module 6 outputs the response message 10, which is received by the data transfer acceleration module 11 of the target system 5. The data transfer acceleration module 11 of the target system 5 can then directly, indicated by an arrow 507, read out a further data transfer block from the data transfer block buffer and can transfer the further data transfer block to the system interface module 6. This means that a space in the data transfer block buffer of the data transfer acceleration module 11 of the target system 5 becomes free. Thus, the data transfer acceleration module 11 of the target system 5 passes the response message 10 to the source system 2, in order to cause the sending of a further data transfer block, as it can now receive a data transfer block again. This is sent by a corresponding information message 15, indicated by an arrow 508. The data transfer block buffer in the target system 5 is then full again, so that no further response messages 13 are sent.

Indicated by an arrow 509, the data transfer block buffer of the data transfer acceleration module 11 of the source system 2 is also full. Only after the data transfer acceleration module 11 of the source system 2, indicated by an arrow 510, has received a new response message 10, can a further data transfer block, indicated by an arrow 511, be transmitted to the target system 5, and correspondingly space created in the data transfer block buffer in the source system 2.

FIG. 5 illustrates, firstly, by the arrows 501 to 505, how the data transfer block buffer of the data transfer acceleration module 11 in the target system 5 can be accelerated by the provision of in each case one data transfer acceleration module 11 in the source system 2 and in the target system 5. Secondly, FIG. 5 illustrates that despite a full data transfer block buffer of both data transfer acceleration modules 11, time saving in the data transmission is possible, because, as indicated by the arrow 511, a data transfer block can be transmitted faster to the target system 5.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A system, comprising:
a source system comprising a source information storage, a file reader module, and a system interface module; and
a target system comprising a target information storage, a system interface module, a payload buffer module, and a storage access module, wherein
the source system is communicatively coupled to the target system via a bidirectional data line,
the source system is configured to read out, using the file reader module, the source information storage after receiving a response message from the target system, and the source system is configured to pack information read out from the source information storage to form a data transfer block and to send the data transfer block to the target system via the bidirectional data line,
the source system requires a first latency time to read out the source information storage and pack the data transfer block,
the target system is configured to receive the data transfer block, to extract the information contained in the received data transfer block, to write the extracted information into the payload buffer module, then to create a response message and to transmit the information from the payload buffer module to the target information storage using the storage access module,
the target system requires a second latency time to extract and write the information and to create the response message,
the source system or the target system further comprises a data transfer acceleration module comprising a data transfer block buffer,
when the data transfer acceleration module is arranged in the source system the data transfer acceleration module is arranged between the bidirectional data line and system interface module and the data transfer acceleration module is configured to
receive a first data transfer block and to send the first data block, via the bidirectional data line,
output a response message to the system interface module after receiving a data transfer block to cause the packing of at least one further data transfer block,
cache the further data transfer block in the data transfer block buffer, and
send a further data transfer block cached in the data transfer block buffer to the target system after receiving a response message from the target system, and
when the data transfer acceleration module is arranged in the source system, the data transfer acceleration module is arranged in the target system between the bidirectional data line and the system interface module and the data transfer acceleration module is configured to
receive a first data transfer block and to pass the first data transfer block to the system interface module,
output a response message after receiving a data transfer block and to send the response message via the bidirectional data line in order to cause sending of at least one further data transfer block from the source system to the target system,
cache at least one further data transfer block in the data transfer block buffer and
pass a further data transfer block to the system interface module after receiving a response message from the system interface module, or
send a negative response message via the data line after receiving the negative response message from the system interface module and to delete all further data transfer blocks from the data transfer block buffer.

10. The system of claim 9, wherein the data transfer acceleration module in the source system or in the target system is further configured to output response messages until the data transfer block buffer of the source system or of the target system is full.

11. The system of claim 9, wherein the source system and the target system are configured to use Unified Diagnostic Services as a communication protocol.

12. The system of claim 9, wherein the source information storage or the target information storage comprises flash memory.

13. The system of claim 9, wherein the target system is an embedded system.

14. The system of claim 9, wherein the source system is a server or a server cluster and at least one part of the bidirectional data line runs through the internet.

15. A vehicle comprising:
a target system comprising a target information storage, a system interface module, a payload buffer module, and a storage access module, wherein
the target system is communicatively coupled to a source system via a bidirectional data line,
the source system comprises a source information storage, a file reader module, and a system interface module,
the source system is configured to read out, using the file reader module, the source information storage after receiving a response message from the target system, and the source system is configured to pack information read out from the source information storage to form a data transfer block and to send the data transfer block to the target system via the bidirectional data line,
the source system requires a first latency time to read out the source information storage and pack the data transfer block,
the target system is configured to receive the data transfer block, to extract the information contained in the received data transfer block, to write the extracted information into the payload buffer module, then to create a response message and to transmit the information from the payload buffer module to the target information storage using the storage access module,
the target system requires a second latency time to extract and write the information and to create the response message,
the target system further comprises a data transfer acceleration module comprising a data transfer block buffer,
the data transfer acceleration module is between the bidirectional data line and the system interface module and the data transfer acceleration module is configured to
receive a first data transfer block and to pass the first data transfer block to the system interface module,
output a response message after receiving a data transfer block and to send the response message via the bidirectional data line in order to cause sending of at least one further data transfer block from the source system to the target system,
cache at least one further data transfer block in the data transfer block buffer and
pass a further data transfer block to the system interface module after receiving a response message from the system interface module, or
send a negative response message via the data line after receiving the negative response message from the system interface module and to delete all further data transfer blocks from the data transfer block buffer.

16. A method comprising:
reading out, by a file reader module of a source system, source storage information after receiving a response message from a target system, wherein the source system further comprises a source information storage and a system interface module, and wherein the target system comprises a target information storage, a system interface module, a payload buffer module, and a storage access module;
packing, by the source system, information read out from the source information storage to form a data transfer block;
sending, by the source system to the target system via a bidirectional data line, the data transfer block, wherein the source system requires a first latency time to read out the source information storage and pack the data transfer block;
receiving, by the target system, the data transfer block;
extracting, by the target system, the information contained in the received data transfer block;
writing, by the target system, the extracted information into the payload buffer module;
creating, by the target system, a response message; and
transmitting, by the target system, the information from the payload buffer module to the target information storage using the storage access module,
wherein the target system requires a second latency time to extract and write the information and to create the response message,
wherein the source system or the target system further comprises a data transfer acceleration module comprising a data transfer block buffer,
wherein when the data transfer acceleration module is arranged in the source system the data transfer acceleration module is arranged between the bidirectional data line and system interface module and the method further comprises
receiving, by the data transfer acceleration module, a first data transfer block and to send the first data block, via the bidirectional data line,
outputting, by the data transfer acceleration module, a response message to the system interface module after receiving a data transfer block to cause the packing of at least one further data transfer block,
caching, by the data transfer acceleration module, the further data transfer block in the data transfer block buffer, and
sending, by the data transfer acceleration module, a further data transfer block cached in the data transfer block buffer to the target system after receiving a response message from the target system, and
wherein when the data transfer acceleration module is arranged in the source system, the data transfer acceleration module is arranged in the target system between the bidirectional data line and the system interface module and the method further comprises
receiving, by the data transfer acceleration module, a first data transfer block and to pass the first data transfer block to the system interface module,
outputting, by the data transfer acceleration module, a response message after receiving a data transfer block and to send the response message via the bidirectional data line in order to cause sending of at least one further data transfer block from the source system to the target system,
caching, by the data transfer acceleration module, at least one further data transfer block in the data transfer block buffer and
passing, by the data transfer acceleration module, a further data transfer block to the system interface module after receiving a response message from the system interface module, or
sending, by the data transfer acceleration module, a negative response message via the data line after receiving the negative response message from the system interface module and to delete all further data transfer blocks from the data transfer block buffer.

17. The method of claim 16, wherein
the source storage information is an update to the target system, and the update is a parameter dataset, an application program, a firmware, or
the source storage information is new information introduced into the target system.
